(19) United States
(12) Patent Application Publication
(10) Pub. No.: US 2009/0123016 A1
(43) Pub. Date: May 14, 2009

(54) Headpiece with releasably engaged earbud securement system

(76) Inventor: Mark Joseph Rise, Fort Collins, CO (US)

Correspondence Address: CR MILES, P.C.;CRAIG R. MILES, 405 MASON COURT, SUITE 119, FORT COLLINS, CO, 80524, US

(21) Appl. No.: 11/983,644

(22) Filed: Nov. 9, 2007

(51) Int. Cl. H04R 1/02

(52) U.S. Cl. 381/380

(57) ABSTRACT

A resiliently flexible headpiece pivotally coupled to a pair of earbud securement elements each of which releasably engage the external surface of a corresponding discrete pair of earbuds.

### I. BACKGROUND

A resiliently flexible headpiece pivotally coupled to a pair of earbud securement elements each of which releasably engage the external surface of a corresponding discrete pair of earbuds.

There is a large commercial market for conventional earbuds. Earbuds are typically sold in pairs each earbud providing a discrete earphone configured to insert into the ear. The earbud converts electrical signals to sound heard by the earbud wearer through the earphone portion of the earbud. A numerous and wide variety of earbuds are available to the consumer. Two non-limiting examples of conventional earbuds which may be available include APPLE-Earphones for APPLE IPOD, Model MA662G/A SKU: 8278482 available from BEST BUY and BOS—In Ear Headphones, Model: In ear SKU: 7997322 available from BEST BUY.

A substantial problem with conventional earbuds can be that each discrete earbud inserted into the ear of the earbud wearer can fall out of the ear. This can happen even when the earbud wearer is sedentary and occurs more frequently as activity of the earbud wearer increases. While conventional headphones having a pair of speakers fixedly attached to a headband can be utilized to replace the earbuds for certain applications, there does not appear to be any headpiece which engages an earbud to assist in maintaining insertion of the earbuds in the ears and further releases the earbuds to allow use of the earbuds without the headpiece.

A second substantial problem with conventional earbuds can be that each discrete earbud may not locate in the ear with the proper orientation. One aspect of this problem can be that there is no manner to forcibly urge the earbud inwardly to engage the inside of the ear. A second aspect of this problem can be that there may be no axis of rotation on which an inward force can act in relation to the earbud to encourage a particular path of travel or location in the ear.

A third substantial problem with conventional earbuds can be that when removed from the ears there is no means to maintain the earbuds in the proper spatial relation for re-insertion in the ear.

As to each of these substantial problems with conventional earbuds, the invention described herein provides devices and methods which afford a practical solution.

### II. SUMMARY OF THE INVENTION

Accordingly, a broad object of the invention can be to provide a resiliently flexible headpiece which provides a pair of earbud securement elements each of which releasably engage the external surface of a corresponding discrete pair of earbuds.

A second broad object of the invention can be to provide a resiliently flexible headpiece pivotally coupled to a pair of earbud securement elements each of which releasably engage the external surface of a corresponding discrete pair of earbuds.

A third broad object of the invention can be to provide a method of producing a resiliently flexible headpiece which provides a pair of earbud securement elements each of which releasably engage the external surface of a corresponding discrete pair of earbuds and further including embodiments which provide a pivotally coupled pair of earbud securement elements.

A fourth broad object of the invention can be to provide a method of releasably securing a pair of discrete earbuds to a headpiece.

Naturally, further objects of the invention are disclosed throughout other areas of the specification, drawings, photographs, and claims.

### III. A BRIEF DESCRIPTION OF THE DRAWINGS

FIG. 1 illustrates a particular method of utilizing a headpiece which releasably secures a pair of earbuds.

FIG. 2 is a perspective view of an embodiment of the headpiece which releasably secures a pair of earbuds.

FIG. 3 is top view of an embodiment of the headpiece which releasably secures a pair of earbuds.

FIG. 4 is a front view of an embodiment of the headpiece which releasably secures a pair of earbuds.

FIG. 5 is an end view of an embodiment of the headpiece which releasably secures a pair of earbuds.

FIG. 6 is an exploded view of an embodiment of a earbud securement element in which a discrete earbud releasably secures.

FIG. 7 is perspective view of an embodiment of a earbud securement element in which a discrete earbud releasably secures which further includes a compressible element.

FIG. 8 is perspective view of an embodiment of a earbud securement element which further includes a flexible portion in which a discrete earbud releasably secures.

FIG. 9 is perspective view of an embodiment of a earbud securement element in which a discrete earbud releasably secures.

FIG. 10 is perspective view of an embodiment of a earbud securement element in which a discrete earbud releasably secures.

### IV. DETAILED DESCRIPTION OF THE PREFERRED EMBODIMENTS

A resiliently flexible headpiece pivotally coupled to a pair of earbud securement elements which releasably engage the external surface of a corresponding discrete pair of earbuds to locate each one for removable insertion into an ear.

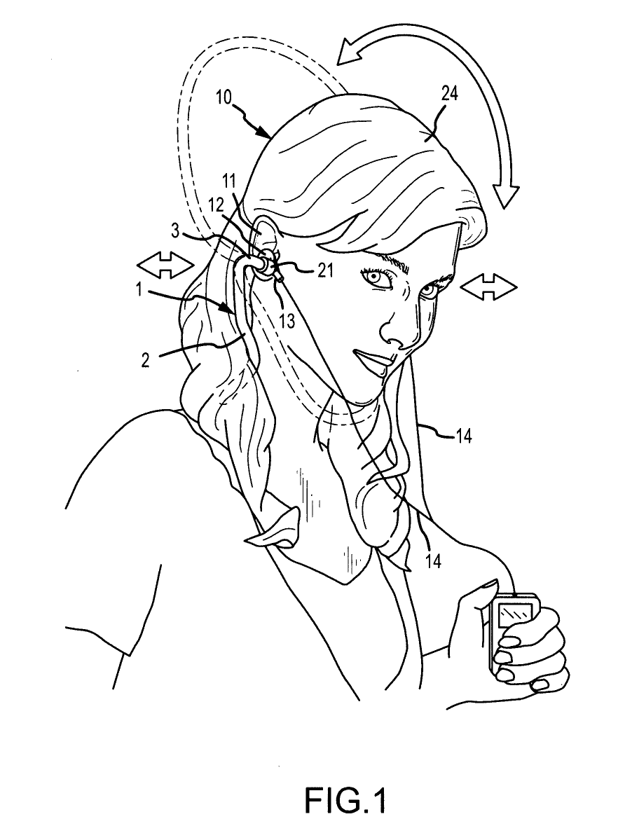

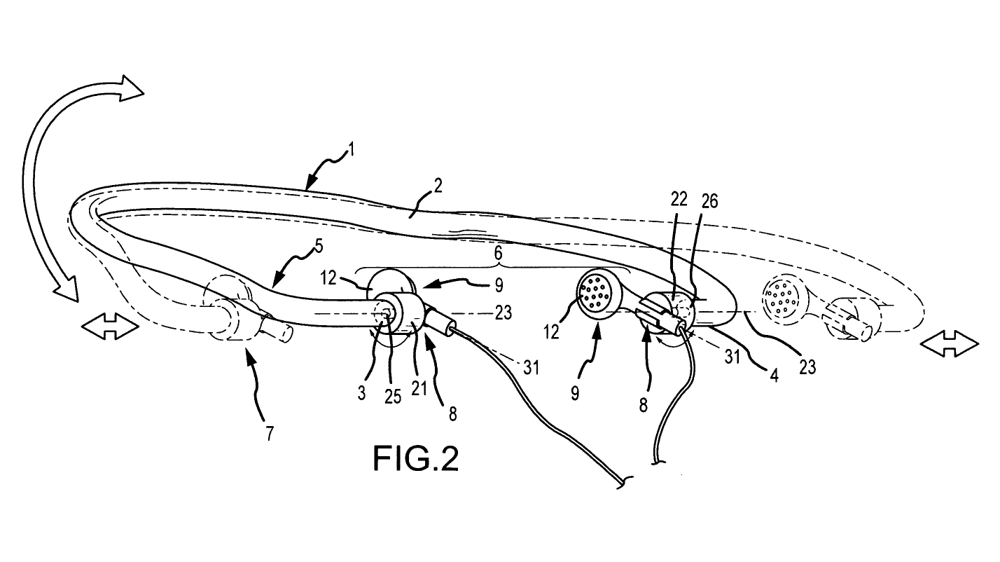

Now referring primarily to FIGS. 1 and 2, a headpiece (1) can provide a resiliently flexible body (also referred to as a resiliently flexible arcuate body) (2) disposed between a first end (3) and a second end (4) configured to provide an unflexed condition (5)(shown in solid object lines in FIG. 2) which locates the first end (3) and the second end (4) in opposed relation a distance (6) apart. As to certain embodiments, the resiliently flexible body (1) can be sufficiently arcuate to locate the first end (3) and the second end (4) in opposed relation a distance (6) apart. The resiliently flexible body (2) or resiliently flexible arcuate body (2) can be produced from a numerous and wide variety of materials providing resilient flexure sufficient to allow the resiliently flexible body (2), or resiliently flexible arcuate body, to flex between the unflexed condition (5) and a flexed condition (7) (shown in dashed object lines in FIG. 2). The flexed condition (7) of the resiliently flexible body (2) increases the distance (6) between the first end (3) and the second end (4). The term “arcuate” as utilized is not intended to be limiting with regard to the configuration of the headpiece (1) but typically the headpiece is configured to encircle a part of the head (24) to locate the first end (3) and the second end (4) in opposed relation at a location proximate to each ear (11). However, the headpiece (1) can provide a resiliently flexible body (1) of any configuration which properly locates the first end (3) and the second end (4) as above-described.

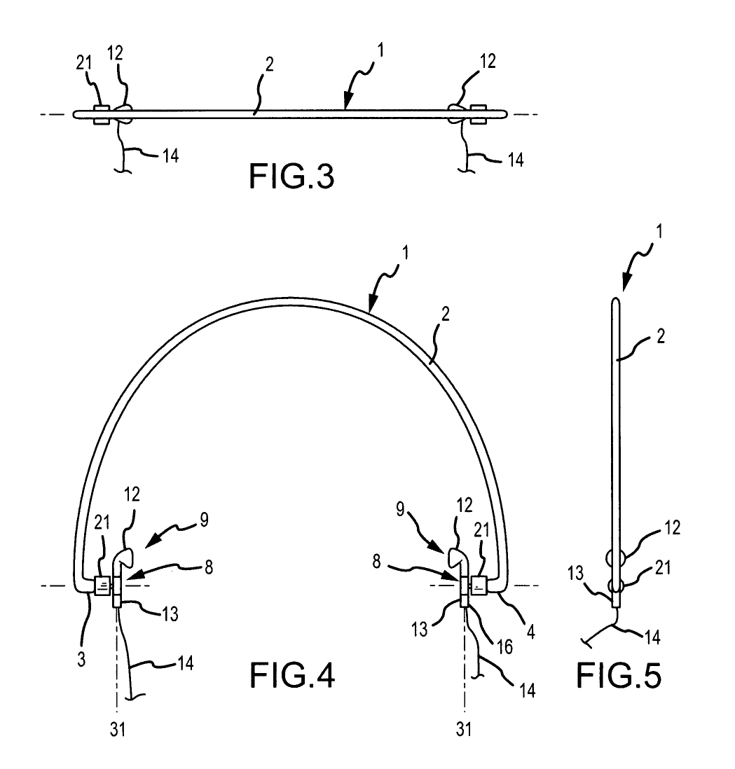

Now referring primarily FIGS. 1-6, one each of a pair of earbud securement elements (8) can be correspondingly coupled to the first end (3) and the second end (4) of the resiliently flexible arcuate body (2). Generally, each of the pair of earbud securement elements (8) has a configuration which releasably secures an earbud (9) or allows releasable securement of an earbud (9). When secured by one of the pair of earbud securement elements (8), the earbud (9) generally travels in response to travel of the entire headpiece (1). For example, when a headpiece user (10) moves the entire headpiece (1) from a first location to a second location the releasably secured earbud (9) also travels from the first location to the second location. Also, the earbud (9) secured to the headpiece (1) specifically travels in response to flexure of the resiliently flexible body (2) from the unflexed condition (5) to the flexed condition (7) which allows the secured earbud (9) to be releasably engaged with the ear (11) of headpiece user (10) by flexure of the resiliently flexible body (2). When an earbud (9) releases from the earbud securement element (8), the earbud (9) can operate in the conventional manner discrete from the headpiece (1). The released earbud (9) can be again secured to the earbud securement element (8) to travel in response to general travel of the headpiece (1) or flexure of the resiliently flexible arcuate body from the unflexed condition (5) to the flexed condition (7) and in returning to the unflexed condition (5) or to a location between the unflexed condition (5) and the flexed condition (7).

Generally, earbuds (9) (also referred to as a pair of earbuds or an earbud) can be obtained as a pair of earbuds (9). The pair of earbuds (9) are not fixedly coupled to the headpiece (1) but can be obtained discrete from the headpiece (1) as separate components; however, this description is not intended to preclude packaging of the headpiece (1) with the discrete pair of earbuds (9) as a kit with both or one of the pair of earbuds (9) releasably secured to an earbud securement element (8) as above-described in the kit.

Typically, each of a pair of earbuds (9) provides an earpiece (12) coupled to an earpiece support (13). The two parts typically produced a single integral constructional form of the earbud (9). The earpiece (12) of the earbud (9) provides an external surface configured to insert (whether in whole or in part) into an ear (11). The earpiece support (13) couples to the earpiece (12) to provide an external surface which extends outwardly from the earpiece (12) a distance outside of the ear (11) when the earpiece (12) is inserted in the ear (11). The earpiece (12) can be configured in any manner which allows a part of the earpiece (12) to insert into the ear (11). The earpiece support (13) can also be configured in any manner which extends sufficiently outward from the earpiece (12) to allow entry of an electrical conduit (14) to deliver a signal to the speaker (not shown) located inside of the earpiece (12). Understandably, a numerous and wide variety of earbuds (9) can be obtained by the headpiece user (10) discrete from the headpiece (1). As but two non-limiting examples of earbuds which can be obtained by the headpiece user (10): APPLE-Earphones for APPLE IPOD, Model MA662G/A SKU: 8278482 available from BEST BUY and BOSE—In Ear Headphones, Model: In ear SKU: 7997322 available from BEST BUY. Typically, as to the numerous and wide variety of earbuds (9) available to the headpiece user (10), the earpiece support (13) extends a sufficient distance from the earpiece (12) to be received by and removed from (releasably secured) the corresponding earbud securement element (8).

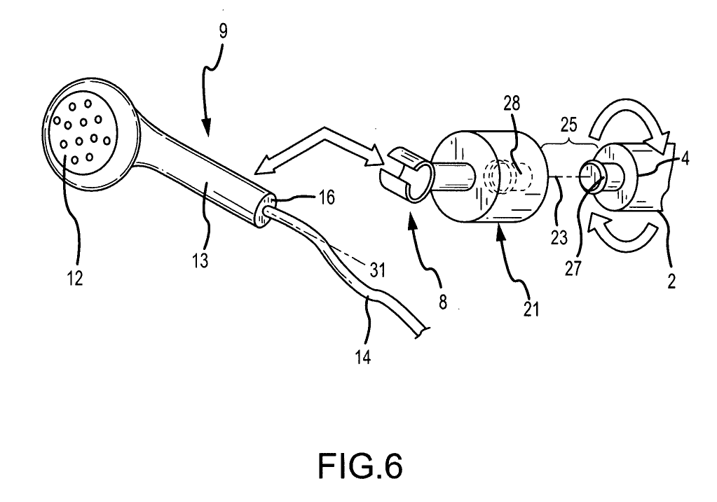

Now referring primarily to FIG. 6, which shows a non-limiting embodiment of the earbud securement element (8), numerous different earbuds (9) can be obtained by the headpiece user (10) each of which provide an earpiece (12) coupled to an earpiece support (13) which can be of generally cylindrical configuration at a first earpiece support end (15). The earpiece support (13) extends a distance outwardly from the earpiece (11) and accepts entry of the electrical conduit (14) at the second earpiece support end (16). The generally cylindrical external surface of the earpiece support (13) can be releasably secured in an earbud securement element (8) correspondingly configured to receive and release the generally cylindrical external surface of the earpiece support (13). Releasable securement can be acheived by insertion of the earpiece support (13) into the earbud securement element (8). The earbud securement element (8) can have a substantially fixed configuration which upon insertion of the earpiece support (13) into the earbud securement element (8) engages sufficiently to releasably secure the earpiece support (13) at a location in the earbud securement element (8). As to certain embodiments of the earbud securement element (8) the configuration can provide releasably secured engagement of the earpiece support (13) with the earbud securement element (8) which allows rotation of the earpiece support (13) about the longitudinal axis (31) of the earpiece support (13).

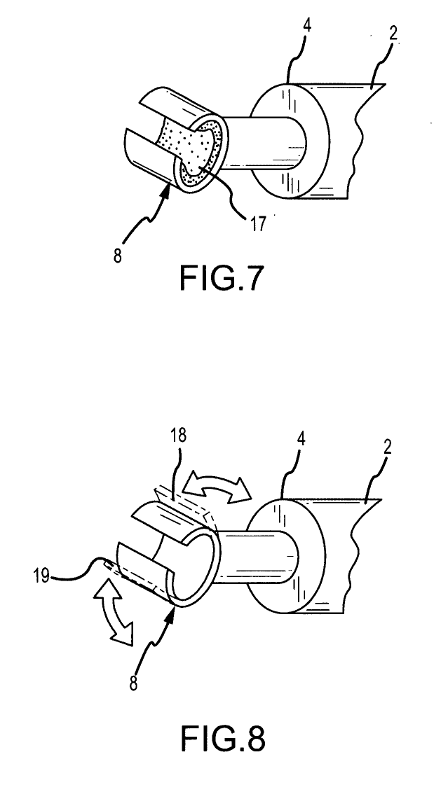

Now referring primarily to FIG. 7, the earbud securement element (8) can further provide a compressible element (17) which can releasably secure the earpiece support (13) upon receiving the earpiece support (13) in the earbud securement element (8). The compressible element (17) can compress to allow adjustable configuration of the earbud securement element (8) in response to engagement with a wide variation of external surface configurations of the earpiece support (13).

Now referring primarily to FIG. 8, the earbud securement element (8) can further provide at least a first flexible securement portion (18) and can further provide a second flexible securement portion (19). The first flexible securement portion (or at least a first flexible securement portion) (18) or the second flexible securement portion or both can flex to releasably secure the external surface configuration of the earpiece support (13).

While various examples of the earbud securement element (8) (whether providing the fixed configuration with or without a compressible element (17) or providing at least one flexible securement portion (18)) as shown in the Figures are configured to releasably secure a substantially cylindrical earpiece support (13), it is not intended that the configuration of the earbud securement element(s) (8) be limited to the releasable securement of a cylindrical earpiece support (13). Rather, the examples provided are intended to provide sufficient description to allow the person of ordinary skill to make and use the numerous and wide variety of configurations of the earbud securement elements (8) which correspond to a similar numerous and wide variety of configurations of earpiece supports (13). As an additional non-limiting example, FIG. 10 shows an embodiment of the earbud securement element (8) which provides a configuration which releasably secures an earpiece support (13) having a tapered external surface (20).

Now referring primarily to FIGS. 2 and 6, the invention can further provide a pair of pivot elements (21)(22) one each of which couple to a corresponding one of the first end (3) and the second end (4) of said resiliently flexible arcuate body (2). Each of the pair of pivot elements (21)(22) can at least rotate about a first pivot axis (23) which extends between said first end (3) and said second end (4) of said resiliently flexible arcute body (2) in the unflexed condition (5). An earbud securement element (8) can couple to each of the pair of pivot elements (21)(22) to provide rotation of the earbud securement element (8) about the first pivot axis (23). The first pivot axis (23) as shown provides an axis in common with each of the first end (3) and the second end (4) of the headpiece (1) in the unflexed condition (5); however, due to manufacturing variation in the headpiece (1) the first pivot axis (23) may not be shared but each of the first end (23) and the second end (24) can each define a first pivot axis (23). Each of these conditions is included in the meaning of a pair of pivot elements (21)(22) which rotate about a first pivot axis (23) which extends between said first end (3) and said second end (4) of the resiliently flexible body (2).

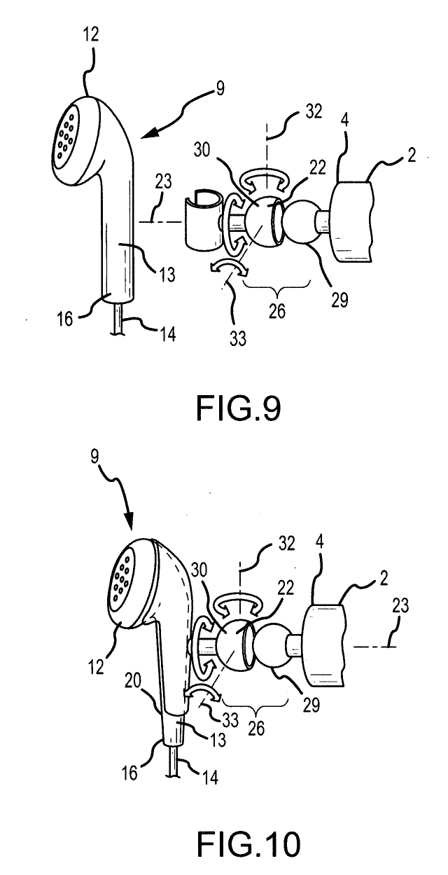

Now referring primarily to FIGS. 6 and 9, each of the pair of pivot elements (21)(22) can each provide a pivot (25)(26). As but two non-limiting examples of the pivot (25)(26) a post (27) rotationally coupled in a socket (28) (as shown in FIG. 6) or a ball (29) can be rotationally coupled in ball socket (30). In configurations of the pivot (22) which provide a ball (29) and a ball socket (30) (or similar pivot), rotation of the pivot elements (21)(22) and the earbud securement element (8) about a second pivot axis (32) and a third pivot axis (33) can be provided. While these two non-limiting examples of pivots (25)(26) are provided, these are not intended to be limiting to the numerous and wide variety of pivots (25)(26) that can be utilized to allow rotation of the pivot elements (21)(22) about the first pivot axis (23).

A releasably secured earbud (9) can travel in response to rotation of the earbud securement element (8) about the first pivot axis (23) to allow adjustment of the location of the releasably secured earbud (9) for insertion into an ear (11) and further allows rotation of the headpiece (1) about the first pivot axis (23), as shown in FIG. 1. Rotation of the headpiece (1) about the first pivot axis (23) allows adjustment of the location of the headpiece (1) about the head (24) of the headpiece user (10).

Now referring primarily to FIGS. 2-10, a particular method of producing the headpiece (1) with releasably engaged earbud (9) securement can include a first step of providing a configuration of the resiliently flexible body (2) (or resiliently flexible arcuate body) disposed between the first end (3) and the second end (4) which in an unflexed condition locates the first end (3) and the second end (4) in opposed relation a distance apart. In a second step, coupling each of a pair of pivot elements (21)(22) to a corresponding one of the first end (3) and the second end (4) of the resiliently flexible arcuate body (2) in a manner by which each of the pair of pivot elements (21)(22) rotate about a first pivot axis (23) which extends between said first end (3) and said second end (4) of the resiliently flexible arcute body (2), as above-described. And further including a third step of coupling each of a pair of earbud securement elements (8) to a corresponding one of said pair of pivot elements (21)(22) to allow rotation of each one of the pair of earbud securement elements (8) about the pivot axis (23) which extends between the first end (3) and the second end (4) of the resiliently flexible arcuate body (2) and providing a part of each one of the pair of earbud securement elements (8) which has a configuration capable of removably engaging a corresponding part of the external surface of a corresponding one of the pair of earbuds (9) to locate each of said pair of earbuds (9) at a location which allows insertion into the ear (11) in the flexed condition (7) of the resiliently flexible body (2).

Now referring primarily to FIGS. 1 and 6, a particular method of securing a pair of earbuds can include a first step of obtaining a pair of earbuds (9) each of which provide an earpiece (12) having an external surface configured to insert into an ear (11) and an earpiece support (13) coupled to the earpiece (12) having an external surface which extends outwardly from the earpiece (12) a distance outside of the ear (11). A second step can be included of removably engaging each of the pair of earbuds (9) with a corresponding one of a pair of earbud securement elements (8) which can be pivotally coupled to rotate about a pivot axis (23) which extends between a first end (3) and a second end (4) of a resiliently flexible body (2) configured to dispose the first end (3) and the second end (4) in opposed relation a distance apart. A third step can be included of flexing the resiliently flexible member (2) to locate said first end (3) of the resiliently flexible body (2) and said second end (4) of the resiliently flexible body (2) a greater distance apart. A fourth step further includes inserting each earpiece (12) of each of the releasably secured pair of earbuds (9) into a corresponding ear (11) and further including a fifth step of unflexing the resiliently flexible body (2) to locate the first end (3) of said resiliently flexible body (2) and the second end (4) of the resiliently flexible body (2) a lesser distance apart to forcibly urge the external surface of each earpiece (12) to a removably fixed location inside a corresponding ear (11). A sixth step can be included of pivoting each earbud securement element (8) about a pivot axis (23) which extends between the first end (3) of the resiliently flexible member and the second end (4) of the resiliently flexible member (2) disposed in opposed relation a lesser distance apart.

As can be easily understood from the foregoing, the basic concepts of the present invention may be embodied in a variety of ways. The invention involves numerous and varied embodiments of a headpiece with releasably engaged earbud securement.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “resiliently flexible arcuate body” should be understood to encompass disclosure of the act of “resiliently flexing an arcuate body”—whether explicitly discussed or not—and, conversely, were there effectively disclosure of the act of “resiliently flexing an arcuate body”, such a disclosure should be understood to encompass disclosure of a “resiliently flexible arcuate body” and even a “means for resiliently flexing an arcuate body.” Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

Thus, the applicant(s) should be understood to claim at least: i) each of the headpieces herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth below are intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. An earbud restraint, comprising:
a) a headpiece which provides a resiliently flexible body disposed between a first end and a second end, and wherein said flexible body has a configuration which in an unflexed condition locates said first end and said second end in opposed relation a distance apart; and
b) a pair of earbud securement elements one each coupled to a corresponding one of said first end and said second end, and wherein a part of each one of said pair of earbud securement elements has a configuration capable of removably engaging the external surface of a corresponding one of a pair of earbuds to locate each of said pair of earbuds at a location which allows insertion into an ear in the flexed condition of said resiliently flexible body.

2. The earbud restraint as described in claim 1, further comprising a compressible element coupled to at least one of said pair of earbud securement elements at a location which allows compressible engagement of said corresponding one of said pair of earbuds.

3. The earbud restraint as described in claim 1, further comprising at least one flexible securement portion of at least one of said pair of earbud securement elements which flexes to removeably engage the external surface of a corresponding one of said pair of earbuds.

4. The earbud restraint as described in any one of claims 1, 2, or 3, further comprising a pair of pivot elements each of which couple to a corresponding one of said first end and said second end of said resiliently flexible body, and wherein each of said pair of pivot elements rotate about a first pivot axis which extends between said first end and said second end of said resiliently flexible body.

5. The earbud restraint as described in claim 4, further comprising a pivot having a post element rotatably engaged in a socket element which allows each of one of said pivot elements to rotate about said first pivot axis which extends between said first end and said second end of said resiliently flexible body.

6. The earbud restraint as described in claim 4, further comprising a pivot having a ball element rotatably engaged in a ball socket element which allows each of one of said pivot elements to at least rotate about said first pivot axis which extends between said first end and said second end of said resiliently flexible body.

7. A method of producing an earbud restraint, comprising the steps of:
a) providing a resiliently flexible body disposed between a first end and a second end, and wherein said flexible body has a configuration which in an unflexed condition locates said first end and said second end in opposed relation a distance apart; and
b) coupling a pair of earbud securement elements one each to a corresponding one of said first end and said second end, and wherein a part of each one of said pair of earbud securement elements has a configuration capable of removably engaging the external surface of a corresponding one of a pair of earbuds to locate each of said pair of earbuds at a location which allows insertion into an ear in the flexed condition of said resiliently flexible body.

8. The method of producing an earbud restraint as described in claim 7, further comprising the step of coupling a compressible element to at least one of said pair of earbud securement elements at a location which allows compressible engagement of said corresponding one of said pair of earbuds.

9. The method of producing an earbud restraint as described in claim 7, further comprising the step of providing at least one flexible securement portion of at least one of said pair of earbud securement elements which flexes to removeably engage the external surface of a corresponding one of said pair of earbuds.

10. The method of producing an earbud restraint as described in any one of claims 7, 8, or 9, further comprising the step of coupling each of a pair of pivot elements to a corresponding one of said first end and said second end of said resiliently flexible body, and wherein each of said pair of pivot elements rotate about a first pivot axis which extends between said first end and said second end of said resiliently flexible body.

11. The method of producing an earbud restraint as described in claim 10, further comprising the step of rotatably engaging a post element in a socket element which allows each of one of said pivot elements to rotate about said first pivot axis which extends between said first end and said second end of said resiliently flexible body.

12. The method of producing an earbud restraint as described in claim 10, further comprising the step of rotatably engaging a ball element in a ball socket element which allows each of one of said pivot elements to at least rotate about said first pivot axis which extends between said first end and said second end of said resiliently flexible body.

13-20. (canceled)
